(19) United States
(12) Patent Application Publication
(10) Pub. No.: US 2013/0060977 A1
(43) Pub. Date: Mar. 7, 2013

(54) Disconnection or reconnection of external device

(71) Applicant: Dukkyu Chun, Seongnam-shi (KR)

(72) Inventor: Dukkyu Chun, Seongnam-shi (KR)

(21) Appl. No.: 13/199,599

(22) Filed: Sep. 6, 2011

(51) Int. Cl. G06F 13/12

(52) U.S. Cl. 710/73

(57) ABSTRACT

According to one aspect of this invention, there is provided a computer keyboard having a predetermined specific key to request a computer to perform a predetermined function for/of disconnection or reconnection of an external device, and arrow keys. The predetermined specific key is positioned close to the arrow keys, and the predetermined specific key and the arrow keys are so configured that a user can display a device list, select an external device among the device list, and request disconnection or reconnection of the external device to the computer, by manipulation(s) of the predetermined specific key and the arrow keys only. The predetermined specific key may be a special purpose key.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND

When removing a removable external device connected to a computer system, it is highly recommended that a user should go through a set of steps to prepare for actual removal (unplugging) of the external device. Depending on the internal condition of the removable device, it is unsafe, resulting in loss of information and possibly unrecoverable internal damage to the removable external device, if the device is simply unplugged from the computer. To prevent this problem, many computer operating systems have provided specific software programs or utilities. In Microsoft Windows, a utility called “Safely Remove Hardware” is provided. The “Safely Remove Hardware” utility contains a step or process to “stop” an external device, as a result of which a user can safely remove the device from a computer. More particularly, at the process to “stop” an external device, a computer performs tasks to prepare the device for actual removal (unplugging) from the computer, such as, for example, transferring buffered data to an external device and logically severing the device from the computer. The technology regarding this process is well known to those with ordinary skill in this art, and will not be described in further detail.

In this invention (application), a term “disconnection” will be used for a computer process to prepare an external device for actual removal (unplugging) from a computer, such as, for example, “stopping” process of “Safely Remove Hardware” utility.

As a common practice, a user clicks a miniature icon in the system tray located at the bottom right corner of the Windows graphical user interface screen. The related icon is one of many icons in the system tray. In the prior art, this operation is cumbersome as the icon is small in size and the location is far at the bottom right corner.

According to a prior art, disclosed at www.safelyremove.com, for example, a utility similar to “Safely Remove Hardware” is provided. But it provides not only a process for disconnection, but also for “reconnection”, as a result of which the device can be readily accessed by a computer again. More particularly, at the process for reconnection, a computer performs tasks, such as, but not limited to, logically connecting an external device to a computer. The external device is incorporated into the computer's file system. The technology regarding this process is well known to those with ordinary skill in this art, and will not be described in further detail.

If an external device was disconnected but has not been physically (actually) unplugged from a computer, a user can perform reconnection of the external device by this utility, without actually unplugging and then re-plugging the external device.

In this invention (application), a term “safe disconnection” will be used for a utility for disconnection or reconnection of external device(s).

### BRIEF DESCRIPTION OF THE SEVERAL VIEWS OF THE DRAWINGS

FIG. 1 is an illustration of the access means provided by the Microsoft Windows operating system to the “Safely Remove Hardware” utility, according to prior art;

FIG. 2 is an illustration of an IBM/Windows keyboard layout according to prior art;

FIG. 3 is a block diagram illustrating a computer system according to one embodiment of this invention;

FIG. 4 is an illustration of a keyboard layout according to one embodiment of this invention;

FIG. 5 is an illustration of the safe disconnection application's decision process, according to one embodiment of this invention;

FIG. 6 is an illustration of the abbreviated windows processing flowchart for the safe disconnection application, according to one embodiment of this invention;

FIG. 7 is an illustration of the reconnection of the last disconnected device processing flowchart for the safe disconnection application according to one embodiment of this invention;

FIG. 8 is an illustration of the disconnection of the last connected device processing flowchart for the safe disconnection application according to one embodiment of this invention;

FIG. 9 is a sample illustration of the safe disconnection application's abbreviated graphical user interface;

FIG. 10 is a sample illustration of the safe disconnection application's main graphical user interface;

FIG. 11 is an illustration of a keyboard according to another embodiment of this invention;

FIG. 12 is an illustration of a keyboard according to another embodiment of this invention;

FIG. 13 is another sample illustration of the safe disconnection application's abbreviated graphical user interface, according to one embodiment of this invention;

FIG. 14 is an illustration of multiple special purpose keys on a keyboard according to one embodiment of this invention;

FIG. 15 illustrates a flowchart for slot-specific disconnection or reconnection of external device according to one embodiment of this invention;

FIG. 16 is an illustration of multiple special purpose keys on a keyboard according to another embodiment of this invention; and

FIG. 17 is an illustration of a keyboard layout according to another embodiment of this invention.

### DETAILED DESCRIPTION OF THE INVENTION

One aspect of this invention is to provide means to access and perform safe disconnection procedures easily and quickly utilizing a computer keyboard.

According to one aspect of this invention, there is provided a computer keyboard comprising an additional predetermined specific key to request a computer to perform a predetermined function for/of disconnection or reconnection of an external device. The predetermined function comprises one of the following: slot-specific disconnection, device-specific disconnection, drive-specific disconnection, slot-specific reconnection, device-specific reconnection, or drive-specific reconnection of the external device.

The additional predetermined specific key may be a special purpose key.

The computer keyboard may further comprise a touch screen, and the additional predetermined specific key to request a computer to perform device-specific disconnection or device-specific reconnection, may be a soft key displayed on the touch screen.

According to one aspect of this invention, there is provided a computer keyboard comprising a predetermined specific key to request a computer to perform a predetermined function for/of disconnection or reconnection of an external device, and arrow keys. The predetermined specific key is positioned close to the arrow keys, and the predetermined specific key and the arrow keys are so configured that a user can display a device list, select an external device among the device list, and request disconnection or reconnection of the external device to the computer, by manipulation(s) of the predetermined specific key and the arrow keys only.

According to one aspect of this invention, there is provided a computer system comprising a computer, and a keyboard which can be connected to the computer. The keyboard comprises a predetermined specific key to request the computer to perform a predetermined function for/of disconnection or reconnection of an external device, and arrow keys. The predetermined specific key is positioned close to the arrow keys, and the predetermined specific key and the arrow keys are so configured that a user can display a device list, select an external device among the device list, and request disconnection or reconnection of the external device to the computer, by manipulation(s) of the predetermined specific key and the arrow keys only.

The manipulations may be: manipulation of the predetermined specific key, to display a device list; manipulation of the arrow keys, to select an external device among the device list; and manipulation of the predetermined specific key, to request disconnection or reconnection of the external device, to the computer.

The predetermined specific key may be a special purpose key.

According to one aspect of this invention, there is provided a method in a computer system comprising a computer, and a keyboard having predetermined specific key(s). The method comprises requesting the computer to perform a predetermined function for/of disconnection or reconnection of an external device, by manipulation of the predetermined specific key(s); and performing the predetermined function for/of disconnection or reconnection of an external device, in response to the manipulation. The predetermined function comprises one of the following: disconnection of the last connected external device(s), or reconnection of the last disconnected external device(s).

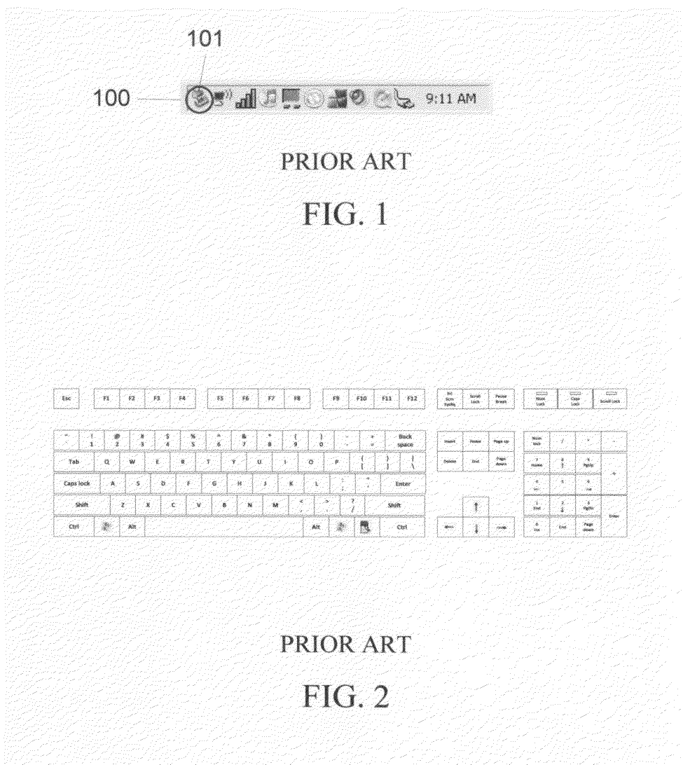

Referring first to the FIG. 1, 100 illustrates an example of the Microsoft Windows operating system's system tray where 101 is one of many miniature icons for “Safely Remove Hardware” utility, of which the capability is provided by Windows operating system. The icon 101 shows that there is at least one removable external device connected to the computer system. Hovering over the pointing-arrow on the top of 101 shows the text “Safely Removal Hardware”. Single-clicking the icon, a device list for external devices connected to a computer is displayed. The system tray 100 typically resides in the bottom right corner of a computer screen and the icon 101 is smaller than other typical size icons, making “Safely Remove Hardware” difficult to be accessed by a user.

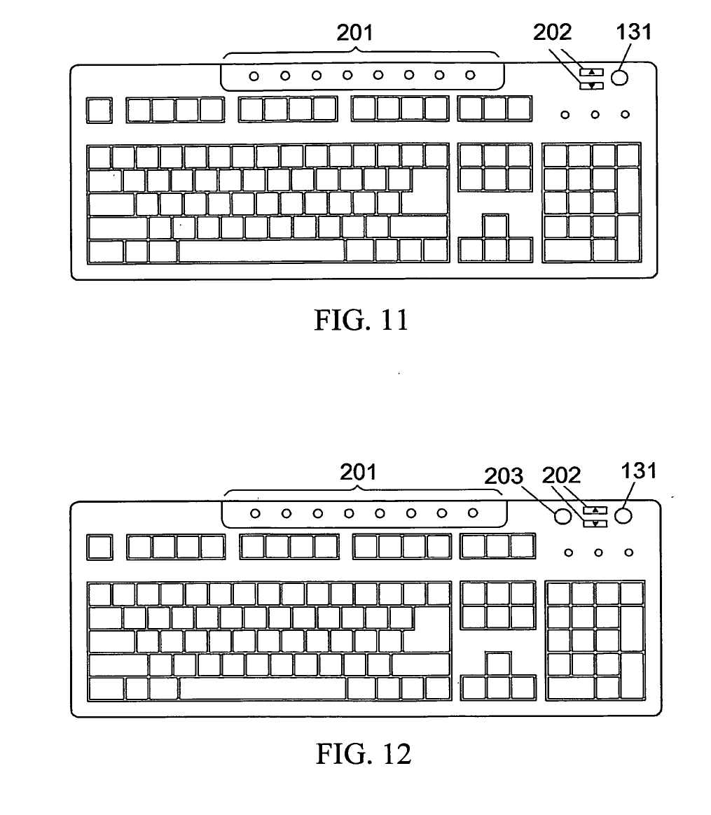

FIG. 2 is an illustration of a keyboard with IBM/Windows keyboard layout, according to a prior art. There are many kinds of computer keyboards, but some of them such as, for example, 101 key enhanced keyboard, 102 key enhanced keyboard and/or 104 key windows keyboards, have been standardized to be used for various computers. They have been widely used and generally considered as “standard” keyboards. Many of modem computer keyboards also have “special purpose key” as illustrated in FIG. 11, in addition to key layouts of standard keyboards. Special purpose keys, which are also called as special function keys, hotkeys or multimedia keys, are additional keys or buttons to provide direct access to various specific functions. There are many special purpose keys which are already in use in the market, such as, for example, a key for volume control, power control, sending e-mail, launching a browser and/or calculation etc.

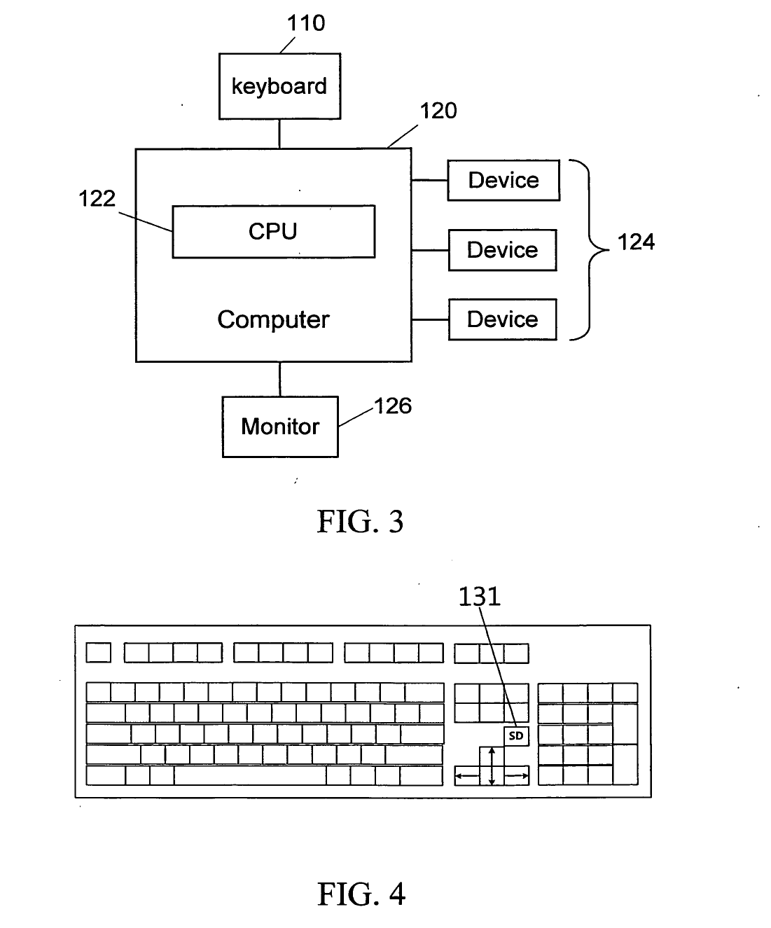

FIG. 3 is a block diagram illustrating a computer system according to one embodiment of this invention. The computer system comprises a computer 120, monitor 126, a keyboard 110 and external device(s) 124. The computer 120 comprises a CPU (central processing unit) 122. The keyboard 110 and monitor 126 and external device 124 are (functionally) connected to the computer 120. The external device 124 may be physically plugged to a certain slot of the computer 120. If an external device is physically or actually plugged to a computer, the external device is logically connected to the computer, or simply expressing, the device is connected to the computer. A device can also be logically connected to the computer if a user performs reconnection of the device.

The external device (or simply “device”) 124 may be an external data storage device or any other type of device which can be logically connected (mounted) to a computer. For example, the external device may be one of, but not limited to, the following: a universal serial bus (USB) data storage device, MP3 player, digital camera, a flash device, a hard drive, a video device, an IEEE 1394 device, a USB device, or a phone.

The CPU 122 operates software programs, such as, but not limited to, operating system or application programs. The application programs includes “safe disconnection” utility or application program associated with a predetermined specific key on a keyboard 110 of this invention. The “safe disconnection” utility is under control of and in cooperation with the operating system. The safe disconnection application starts when operating system such as, for example, Microsoft Windows launches. The safe disconnection application keeps information regarding a device list of device(s) plugged to the computer 120. The devices in the device list are arranged in a chronological order of disconnection or connection (including reconnection). The information on the devices may include device names, slots or drive names.

FIG. 4 illustrates a keyboard according to one embodiment of this invention. The keyboard comprises a predetermined specific key 131, which is an “additional” key, or a key not found in “standard” keyboards. The additional key is a predetermined specific key for disconnection or reconnection of external device(s), or a predetermined specific key to request a computer to perform a predetermined function “for/of” (for or of) disconnection or reconnection of external device(s). More particularly, the key is for predetermined specific capability in conjunction with safe disconnection application software for the use of controlling removable external hardware device disconnection or reconnection process. The additional key is designated as “safe disconnection key” or “SD key” 131. And the SD Key 131 is positioned close to arrow keys. In other words, the SD Key 131 and the arrow keys are in a range wherein a user of ordinary skill can manipulate the keys easily and quickly, without moving hand or finger a long distance.

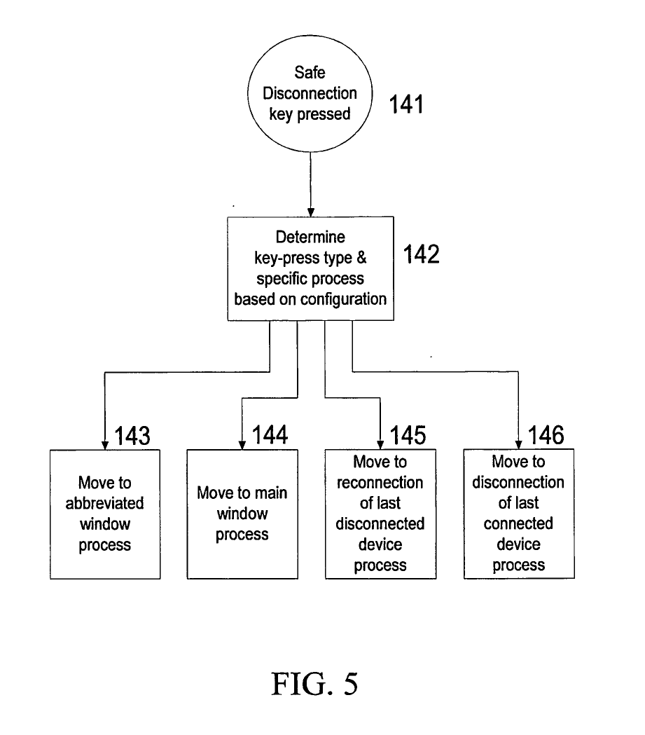

The FIG. 5 illustrates the computer systems internal process of the safe disconnection application and the initial decision making portion of safe disconnection application according to one embodiment of this invention. The safe disconnection application had been readily started during the start-up of computer operating system and is waiting for a predetermined specific input from a user (“initial waiting state”). When a user presses the safe-disconnect (SD) key 131 of FIG. 4, to input command or a request, the operating system detects the SD key being pressed and identifies that the SD key is associated with the safe disconnection application. The operating system gives the SD key input and the control to the safe disconnection application process as illustrated in the process 141 of the FIG. 5. The safe disconnection application of the FIG. 5, when given the control by the operating system, determines the key-press type as shown in the process 142. The key-press type herein refers to certain regularity and/or pattern of key strokes. The SD can be pressed once as a user normally presses a computer keyboard key, twice in a short time interval, three times in a short time interval, four times in a short time interval or prolonged press. In order to further exemplify user activity, the invention introduces the new terms single-press, double-press, triple-press, quadruple-press and long-press. The concept of the new terms is apparent when commonly known terms such as single-click, double-click, triple-click and quadruple-click are taken into consideration. The term single-press is one time press in a normal manner, which the activity is similar to single-click of mouse while the pressing action in this case is applied to a computer keyboard key. The term double-press is the activity similar to double-click of mouse while the pressing action in this case is applied to a computer keyboard key. The term triple-press is the activity similar to triple-click of mouse while the pressing action in this case is applied to a computer keyboard key. The term quadruple-press is the activity similar to quadruple-click of mouse while the pressing action in this case is applied to a computer keyboard key. The time interval between the key-presses is programmable as the time interval between the mouse-clicks is programmable. In fact, the same value may be used to determine different types of key press. In addition, a computer can differentiate between a short press and long press. When the duration of the SD key being pressed exceeds yet another pre-defined interval such as but not limited to one second, the process 142 concludes as a long-press. Otherwise, the process 142 concludes as a short-press. The pre-defined interval for making decision for the single-press or long-press is a programmable entity within the safe disconnection application.

The process 142 determines user activity or a request based upon predetermined criteria and as the result of this decision, the user activity can be concluded to single-press, double-press, triple-press, quadruple-press or long-press of SD key. And based upon predetermined programmable linkages to the processes of the safe disconnection application, single-press, double-press, triple-press and long-press of SD key can be respectively assigned to abbreviated window process, reconnection of the last disconnected device process, disconnection of the last connected device process, and main window process. The relationship and/or linkage of types of key-press and assigned functionality are not permanently fixed but programmable. The safe disconnection application can be configured for the relationship and/or linkage based on user's preference. The processes 143, 144, 145 and 146 illustrate that the control of the safe disconnection application is given to one of the abbreviated window process, reconnection of the last disconnected device process, disconnection of the last connected device process, and main window process. It is also possible assign triple press of the SD Key 131 to “disconnect all devices” process (not illustrated), which is to disconnect all device(s) connected to a computer, instead of disconnection of the last connected external device(s). The technique of disconnecting all devices itself is well known to those with ordinary skills in this art and will not be described.

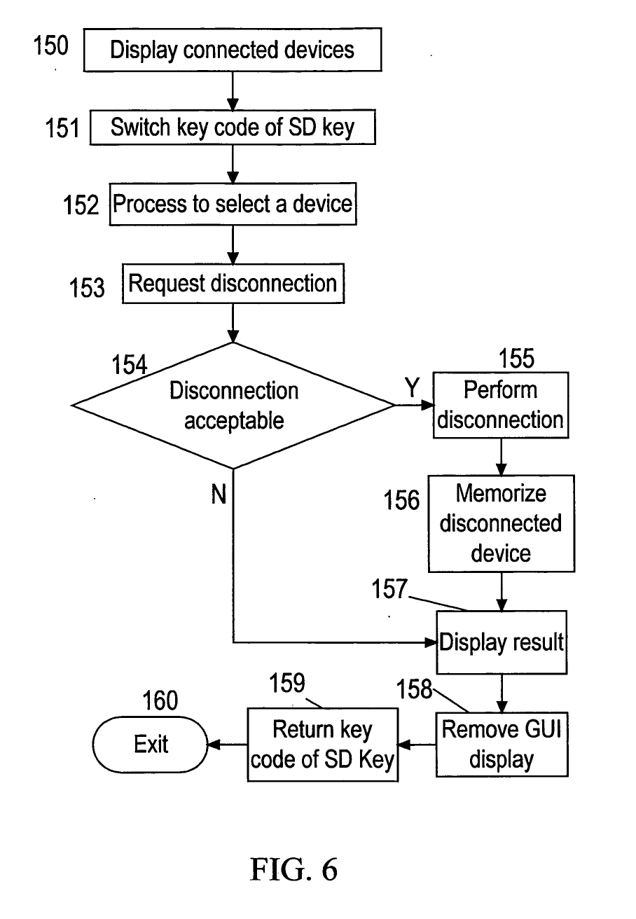

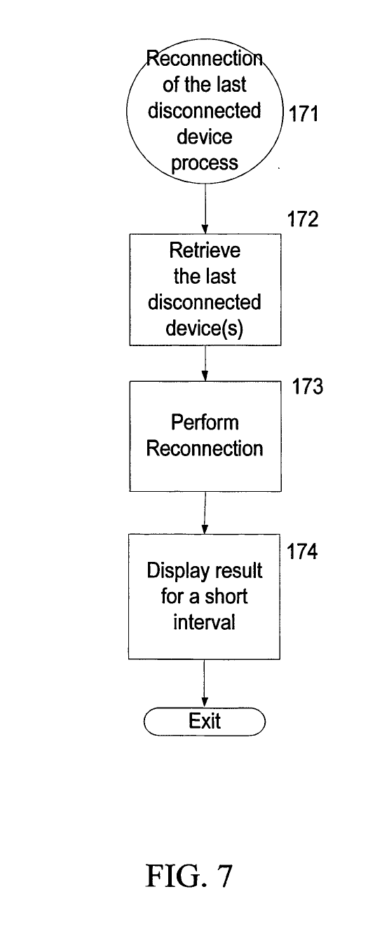

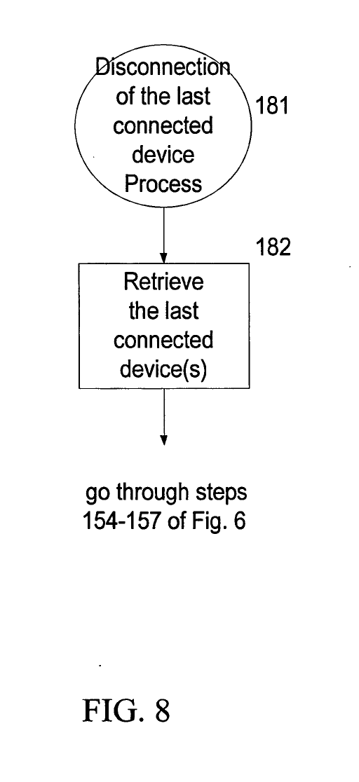

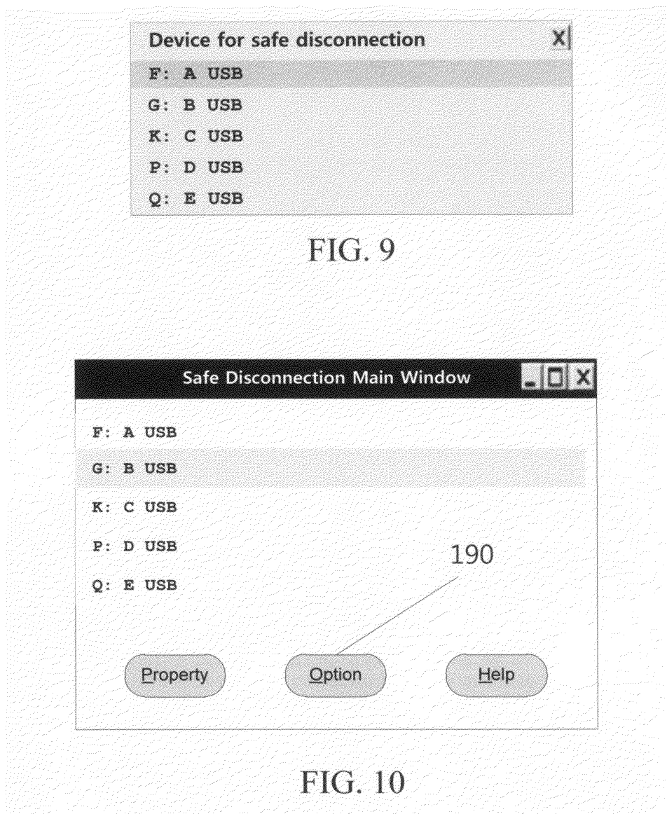

The FIG. 6 illustrates abbreviated safe disconnection process or abbreviated window(s) process of this embodiment, which is intended to disconnect one connected device at a time and to immediately return to the previously operational application with no further user intervention. Upon receiving user's request determined by the process 142 of FIG. 5 and if the request is concluded as an abbreviated disconnect request, or a single press in this embodiment, it moves to the process 150 which subsequently shows a list of connected devices. More particularly, if SD Key 131 is single pressed, a list of devices connected to a computer 120, or a device list is displayed on a display device, such as, for example, a monitor 126. The FIG. 9 illustrates an example of abbreviated safe disconnection graphical user interface (window). This figure displays a sample of device list. The devices are logically connected to the computer. Then, the process proceeds to step 151, and the key code of SD Key 131 is switched to that of ENTER Key. The technique of switching key codes is well known to those who are skilled in this art, and not described in detail. Then, the process proceeds to step 152 and a user can select a specific device for disconnection. Within the process of 152, a user may navigate through the device list to highlight and select a device with arrow keys, which are positioned close to SD Key 131, as shown in FIG. 4. If a user subsequently presses ENTER Key or SD Key 131, the selection of the device is finalized, and a request for disconnection of the selected device is transmitted to a connected computer, as shown in process 153. Then the process proceeds to step 154 to determine whether the disconnection of the selected device is acceptable. If a computer is using a file, or program saved on the device, for example, the disconnection of the device is determined to be unacceptable. Then the process proceeds to step 157 to display result that the device is unacceptable for disconnection, for a short interval. In step 154, if it is determined that the disconnection of the device is acceptable, the process 155 shows that a computer performs disconnection of the device. In process 155, a computer performs tasks to prepare for actual removal (unplugging) of the external device from the computer. Then process 156 memorizes the disconnected device for future reconnection, and the successful result of the request is shown in step 157 for a short time interval. The process 158 shows that all displays including a device list are removed from the screen and the process proceeds to step 159 to return key code of SD Key 131 to original key code. Then the abbreviated safe disconnection process exits without user interaction. The exit of the abbreviated safe disconnection process means a return to the initial waiting state, to wait for user's command or request. A short interval of displaying successful result of abbreviated safe disconnection is a user configurable parameter.

To briefly summarize, in this embodiment, a keyboard comprises an additional predetermined specific key for disconnection or reconnection of external device(s), and arrow keys. The predetermined specific key is positioned close to the arrow keys. In this embodiment, while a device list is displayed, the key code of SD Key 131 is switched to that of ENTER Key. And a user can perform tasks such as displaying a device list, selecting an external device among the device list, and requesting disconnection of the selected external device to a connected computer, by manipulating the predetermined specific key and the arrow keys only. More particularly, when the predetermined specific key is pressed at the initial waiting state, a device list is displayed, and a user can select a device among the device list with arrow keys, and then press the predetermined specific key again to finalize the selection and request disconnection of the device, to a connected computer. In this way, a user can not only directly access Graphical User Interface of safe disconnection utility by just pressing a key on a keyboard, but also complete safe disconnection operations with minimal distance of finger movements.

This technique is very useful for ordinary users, but also especially helpful for the elderly, people with only one hand, or orthopedic patients, such as, for example, shoulder tendinitis.

Upon receiving user's request determined by the process 142 of FIG. 5 and if the request is concluded as main process request, the safe disconnection process moves to main window process and subsequently it shows the list of connected devices as shown in FIG. 10. At a main safe disconnection process, or main window(s) process of this embodiment, a user can disconnect a device in the same way as at abbreviated window(s) process, which will not be illustrated again. The main window process does not terminate and remove graphical user interface automatically after a device is disconnected. It is terminated when a user specifically issues a command to exit from the application. Thus a user can perform disconnection of external devices multiple times consecutively, without opening new safe disconnection windows. The FIG. 10 illustrates a sample of safe disconnection main graphical user interface, which also provides means as to configure the user options and preference of operating the application. A user may choose option tab 190 in order to change the configuration parameters and preference. If the main window process is terminated, it means to return to the initial waiting state.

The FIG. 7 illustrates the reconnection of the last disconnected (external) device process of the safe disconnection application, of this embodiment. This process is intended to reconnect the last disconnected device or devices. Upon receiving user's request determined by the process 142 of FIG. 5 and if the request is for reconnection of the last disconnected device, the safe disconnection process moves to the process 171 and subsequently the process 172 retrieves the information as to the last disconnected device(s) among available device(s). “Available” device means a device which was disconnected but has not been physically unplugged and is still plugged to a computer. Then the process 173 shows that a computer performs reconnection of the retrieved device(s). Process 174 displays result of the reconnection for a short duration and the process is terminated. The exit of this process of the safe disconnection application means a return to the initial waiting state, to wait for user's command or request. This technique is very useful when a user has disconnected a wrong device by mistake, which often happens in everyday practice, and wants to reconnect the device immediately.

If a user has disconnected multiple devices by disconnect all devices process (not illustrated), for example, but wants to reconnect the devices, a user can easily reconnect the multiple devices by just pressing a predetermined specific key on a keyboard, without actually unplugging and then re-plugging all the devices one by one.

According to one embodiment, it is also possible to set configuration so as to retrieve the last disconnected device among entire disconnected devices rather than among available devices. If the retrieved device is not available for reconnection, a message to show unavailability of the device is displayed for short duration.

As described above, the function or capability of “reconnection of the last disconnected (external) device” comprises retrieving the last disconnected device(s) among disconnected device(s) or among available device(s), and performing reconnection of the device(s). The “reconnection of the last disconnected (external) device” is a function or capability to perform above described tasks, regardless of whether there is only one disconnected (or available) device or many disconnected (or available) devices.

The FIG. 8 illustrates the “disconnection of the last connected device” process of the safe disconnection application, of this embodiment. This process is intended to disconnect the last connected device(s). Upon receiving user's request determined by the process 142 of FIG. 5 and if the request is for disconnection of the last connected device, the safe disconnection process moves to the process 181. The process 182 illustrates that it retrieves the last connected device(s) among connected device(s). The devices are logically connected to a computer, either after actual plugging to a computer, or as a result of reconnection process. Then, the process goes through steps 154-157 of FIG. 6, to determine acceptability of the device(s) for disconnection, and perform disconnection of the device(s) if acceptable. The result of the disconnection request is displayed for a short time interval and this process exits without user interaction. The exit of this process of the safe disconnection application means a return to the initial waiting state, to wait for user's command or request. The capability or function of “disconnection of the last connected (external) device” comprises retrieving the last connected device(s) among device(s) connected to a computer, and performing disconnection of the device(s). The “disconnection of the last connected (external) device” is a function or capability to perform above described tasks, regardless of whether there is only one connected device or many connected devices. The device(s) is disconnected if the device(s) is acceptable for disconnection.

This technique is very useful when a user has performed tasks using a certain external device and then wants to remove the device, having finished the task, for instance. A user doesn't have to go through safe disconnection procedures, such as, for example, displaying a device list and selecting a desired device among the device list, and requesting disconnection of the device to a computer. A user can easily disconnect the last connected external device(s) by just pressing a predetermined specific key on a keyboard.

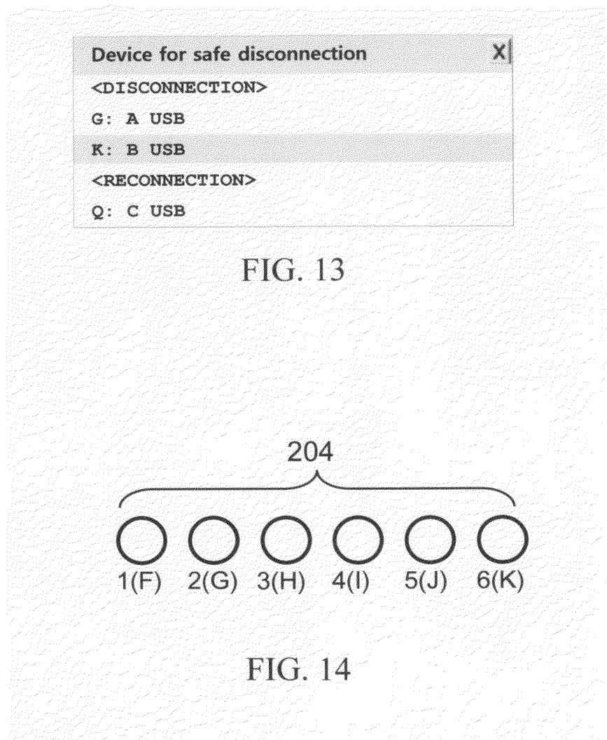

In the above embodiment, a special purpose key was utilized for predetermined functions for/of disconnecting or reconnecting external device, and positioned close to pre-existing arrow keys. A special purpose key can be placed anywhere on a keyboard and can take any form. According to one embodiment, as illustrated in FIG. 11, SD Key 131 can be conveniently positioned as a special purpose key on the upper part of the keyboard, along with other conventional special purpose keys 201. And SD Key 131 is accompanied by closely positioned additional up down arrow keys 202. In this embodiment, a user can easily activate “safe disconnection” utility and display device list, by pressing the SD Key 131 positioned at the right upper corner of the keyboard, at initial waiting state. In this embodiment, as illustrated in FIG. 13, the abbreviated graphical user interface for safe disconnection displays not only a device list for disconnection but also a device list for reconnection. Device(s) available for reconnection is displayed at the device list for reconnection. A user can select a desired external device to be disconnected or reconnected, by navigating up and down at the device list, using closely located up down arrow keys 202. Then a user can finalize the selection and request disconnection or reconnection of the external device, to a connected computer, by just pressing the SD Key 131 again, instead of ENTER Key, while the device list is displayed.

Up down arrow keys 202 can be shared by other pre-existing special purpose keys. According to one embodiment, as illustrated in FIG. 12, up down arrow keys 202 function as volume control keys, by default, which are accompanied by closely located mute key 203. But while abbreviated or main graphical user interface of safe disconnection is displayed, the key codes are switched so that these keys are utilized as up down arrow keys. In this way, a user can utilize a limited space on the keyboard more efficiently.

According to one embodiment, as illustrated in FIG. 14, a computer keyboard comprises multiple special purpose keys for disconnection or reconnection 204, which are arranged together on a certain area on the keyboard, such as, for example, at top portion of the keyboard. Serial characters, such as, for example, serial numbers or alphabets are assigned and labeled on or adjacent to each special purpose key(s). When one of the multiple special purpose keys 204 is single pressed, computer interprets as a request for slot-specific disconnection or reconnection of external device(s). In other words, computer interprets as a slot-specific shortcut key has been pressed. When the special purpose key is double pressed, computer interprets as a request for device-specific disconnection or reconnection of external device(s). And, when the special purpose key is long pressed, computer interprets as a request for drive-specific disconnection or reconnection of external device(s).

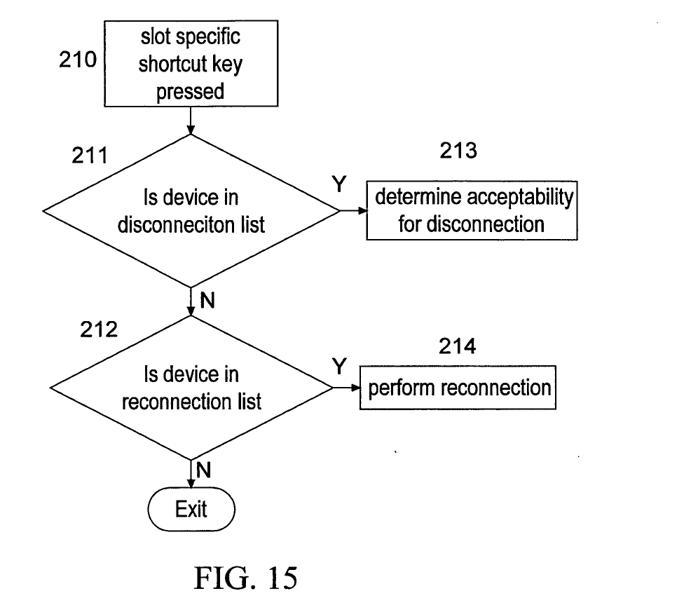

Certain frequently used slots are pre-assigned to the multiple special purpose keys 204 by a user. As illustrated in FIG. 15, when the special purpose key is single pressed, a computer recognizes as slot-specific shortcut key has been pressed (step 210), or as a request for slot-specific disconnection or reconnection of external device(s). Then a device plugged to a slot assigned to the special purpose key is retrieved. Then the process proceeds to step 211 to determine whether the retrieved device is in the device list for disconnection, as in FIG. 13.

If yes, the process proceeds to step 213 to determine acceptability of the device for disconnection. Computer will disconnect the device if the device is acceptable for disconnection. These safe disconnection procedures for disconnection were already described in abbreviated window process, and will not be repeated.

If no, the process proceeds to step 212 to determine whether the device is in the device list for reconnection, as in FIG. 13. If yes, the process proceeds to step 214 to perform reconnection. The safe disconnection procedures for reconnection were already described with reference to FIG. 7, and will not be repeated. If no, it means that no device is plugged to the selected slot, and the process is terminated. The result of disconnection or reconnection request may be displayed for a short duration.

In this way, a user can perform slot-specific disconnection or reconnection of external device(s) plugged to a pre-assigned specific slot, simply and easily by just pressing a special purpose key on a keyboard. This technique is useful when there are certain USB or IEEE 1394 slots, for example, which are more frequently used than other slots, such as, for example, those at the front panel of a desktop computer.

This embodiment also provides direct access means to a device-specific disconnection or reconnection of external device(s). Certain frequently used devices are pre-assigned to the multiple special purpose keys 204 by a user. The flowchart is the similar to that for slot-specific disconnection or reconnection as described above, and is not described in detail but only briefly. If the special purpose key is double pressed, it functions as a device-specific shortcut key. More particularly, if the special purpose key is double pressed, a request for device-specific disconnection or reconnection of external device(s) is transmitted to a connected computer. Then the computer retrieves a device pre-assigned to the special purpose key, and determines whether the device is in the device list for disconnection. If yes, computer goes through steps for disconnection of the device as described above. If no, computer determines whether the device is in the device list for reconnection. If yes, the selected device is reconnected. If no, it means that the selected device is not plugged to a computer and the process is terminated. In this way, a user can perform device-specific disconnection or reconnection of external device, simply and easily by just pressing a special purpose key on a keyboard. This technique is very useful when there are certain USB or IEEE 1394 devices, for example, which are more frequently used than other9s. A user can easily determine which shortcut key to press for disconnection or reconnection of a specific external device, by memorizing one digit number pre-assigned to a device.

If the special purpose key 204 is long pressed, computer recognizes as drive-specific shortcut key has been pressed. Certain drive names are pre-assigned and labeled to special purpose keys as illustrated in FIG. 14. If the drive-specific shortcut key is pressed, a device with a drive name assigned to the shortcut key is retrieved and undergoes procedures for disconnection or reconnection, as in the previous descriptions for device or slot specific shortcut keys. The flowchart is similar to that for slot-specific disconnection or reconnection as described above, and will not be repeated. If a user knows a drive name of the device to disconnect or reconnect, a user can perform disconnection or reconnection of external device(s) simply and easily by just long pressing a special purpose key on a keyboard.

To briefly summarize, the capability or function of slot-specific disconnection or reconnection of external device(s) comprises retrieving device(s) plugged to a slot pre-assigned or corresponding to slot-specific shortcut key or a predetermined user's input, and performing disconnection or reconnection of the device(s). The capability or function of drive-specific disconnection or reconnection of external device(s) comprises retrieving device(s) with a drive name pre-assigned or corresponding to drive-specific shortcut key or a predetermined user's input, and performing disconnection or reconnection of the device(s). The capability or function of device-specific disconnection or reconnection of external device(s) comprises retrieving device(s) pre-assigned or corresponding to device-specific shortcut key or a predetermined user's input, and performing disconnection or reconnection of the device(s). The device(s) is disconnected when the device(s) is acceptable for disconnection.

It should be noted that because multiple special purpose keys for drive, device or slot specific disconnection or reconnection, are arranged together at certain part of a keyboard, a user can easily find and press a desired shortcut key.

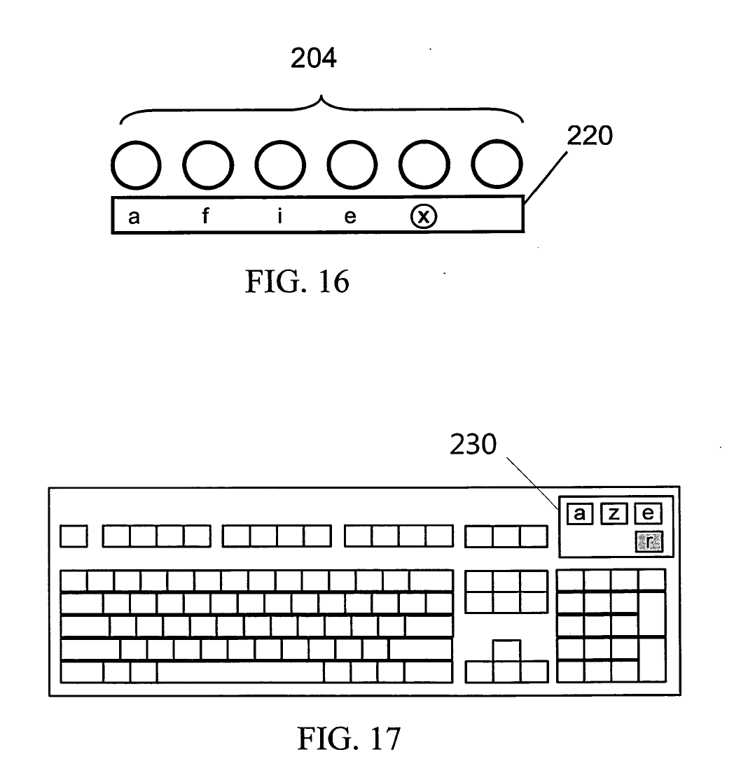

According to one embodiment, as illustrated in FIG. 16, the labels or designations of the multiple special purpose keys for disconnection or reconnection 204 are not fixed but variable. Certain frequently used devices are pre-registered for device-specific disconnection or reconnection, using menu of safe disconnection utility's graphical user interface (not illustrated). In this embodiment, certain small alphabet letter is assigned to each device. And a keyboard comprises a small display device such as, for example, LCD (Liquid Crystal Display) 220 just below the special purpose keys. When a device pre-registered for device-specific disconnection or reconnection, is connected to a computer, the device is assigned to one of the special purpose keys 204, and an alphabet letter pre-assigned to the device is displayed at LCD 220 just below the special purpose key. If a user presses a special purpose key designated as “a”, for example, then computer recognizes as a request for device-specific disconnection of a device which had been pre-assigned as “a”. The LCD also displays circled letters, for device(s) for reconnection. If a key with “®” is pressed, then computer recognizes as a request for device-specific reconnection of a device which had been pre-assigned as “x”. In this embodiment, alphabet letters were utilized, but can be replaced with any other display elements, such as, for example, number, shape, color or icon.

In an embodiment described above with reference to FIG. 14, certain devices were pre-assigned to special purpose keys by a user. If there are only five special purpose keys to be utilized as device-specific shortcut keys, installed on a keyboard, for example, a user can register only five devices for device-specific disconnection or reconnection. However, in this embodiment, a device is not pre-assigned to a special purpose key, but assigned when the device is connected to a computer, if the device had been pre-registered for device-specific disconnection or reconnection by a user. In this way, a user can utilize special purpose keys of limited number, installed on a keyboard more efficiently.

The special purpose keys 204 can take any form. According to one embodiment, the special purpose keys are soft keys, or on-screen keys, displayed on a touch screen 230 installed on a keyboard, as illustrated in FIG. 17. They are device-specific shortcut keys, which are displayed when device(s) is connected to a computer, if the device(s) had been pre-registered for device-specific disconnection or reconnection. The shortcut keys function similar to those in the previous embodiment described with reference to FIG. 16. A key with gray background is for a device for reconnection. If a user presses a special purpose key designated as “a”, for example, then computer recognizes as a request for device-specific disconnection of a device which had been pre-assigned as “a”. A user can easily perform device-specific disconnection or reconnection of external device(s) by just pressing a soft key on a touch screen 230 installed on a keyboard. The soft key can take any form such as, for example, a colored shape, an icon, or any specific area on the touch screen. If a user has assigned a blue color to a specific device, for example, a user can disconnect the device by just tapping a blue icon displayed on a touch screen on a keyboard.

In some embodiments described above, computer performed predefined functions for disconnection or reconnection of external device(s) in response to key press of the specific keys, but any kind of key manipulations may be utilized for disconnection or reconnection of external device(s), such as, for example, key release, key touch, or key rotation.

It would be apparent to those skilled in this art, that any of the functions or capabilities disclosed in this invention, such as, for example, disconnection of the last connected device, slot-specific disconnection or reconnection, device-specific disconnection or reconnection or drive-specific disconnection or reconnection, can be assigned to any of the input methods or options described above or other methods utilizing a predetermined specific key on a keyboard, such as, for example, single press or double press.

A special purpose key in this invention (including claims) can be installed anywhere at a keyboard, and take any form, and be designated in any name.

According to one embodiment, the capability or function of disconnection of the last connected external device(s), or reconnection of the last disconnected external device(s) may be requested or activated by any other input methods in a computer system.

As described above, the terms “remove”, “safely remove” or “safe removal” means actual unplugging of device(s), but the term “Safely Remove Hardware”, or “safe disconnection” is a utility for disconnection or reconnection of external device(s).

Although Microsoft Windows and “Safely Remove Hardware” utility were utilized to explain some aspects of this invention, any other operating system and utility may be applied or utilized, for the same purpose. In an embodiment described above, the key code of SD key was switched to that of ENTER Key while device list was displayed, so that a user can request disconnection or reconnection of external device(s) by pressing SD Key 131. But it is also possible to configure a software program, or in other words, configure SD Key 131, so that a computer can recognize SD key press while device list is displayed, as a request for disconnection or reconnection of selected external device(s), without actually switching a key code.

The computer system described above comprised a computer, keyboard and a monitor, which were separately installed. But in some models of computer, such as, for example, a laptop PC, the computer, keyboard and monitor can be united to form one body. In these models, the term “computer” may mean a unit or a part which can perform computing functions, such as, for example, calculation, controlling, memory, decision making and/or storage.

The expressions such as “a” or “an” to describe any element(s) in this description or claims do not necessarily mean that there is only one of the element. The expressions using plural nouns to describe any element(s) in this description or claims do not necessarily mean that there are necessarily multiple elements.

The invention is not restricted to the particular details listed herein. Indeed, those skilled in the art will appreciate that many other variations from the foregoing description and drawings may be made within the scope of the present invention.

1. A computer keyboard comprising an additional predetermined specific key to request a computer to perform a predetermined function for/of disconnection or reconnection of an external device,
wherein the predetermined function comprises one of the following: slot-specific disconnection, device-specific disconnection, drive-specific disconnection, slot-specific reconnection, device-specific reconnection, or drive-specific reconnection of the external device.

2. The computer keyboard as set forth in claim 1, wherein the additional predetermined specific key is a special purpose key.

3. The computer keyboard as set forth in claim 1,
further comprising a touch screen,
wherein the additional predetermined specific key to request a computer to perform device-specific disconnection or device-specific reconnection, is a soft key displayed on the touch screen.

4. A computer keyboard comprising:
a predetermined specific key to request a computer to perform a predetermined function for/of disconnection or reconnection of an external device; and
arrow keys, wherein:
the predetermined specific key is positioned close to the arrow keys, and
the predetermined specific key and the arrow keys are so configured that a user can:
display a device list;
select an external device among the device list; and
request disconnection or reconnection of the external device, to the computer,
by manipulation(s) of the predetermined specific key and the arrow keys only.

5. The computer keyboard as set forth in claim 4, wherein the manipulations are:
manipulation of the predetermined specific key, to display a device list;
manipulation of the arrow keys, to select an external device among the device list; and
manipulation of the predetermined specific key, to request disconnection or reconnection of the external device, to the computer.

6. The computer keyboard as set forth in claim 4 or 5, wherein the predetermined specific key is a special purpose key.

7. A computer system comprising:
a computer; and
a keyboard which can be connected to the computer,
the keyboard comprising:
a predetermined specific key to request the computer to perform a predetermined function for/of disconnection or reconnection of an external device; and
arrow keys,
wherein the predetermined specific key is positioned close to the arrow keys,
and the predetermined specific key and the arrow keys are so configured that a user can:
display a device list;
select an external device among the device list; and
request disconnection or reconnection of the external device, to the computer,
by manipulation(s) of the predetermined specific key and the arrow keys only.

8. The computer system as set forth in claim 7, wherein the manipulations are:
manipulation of the predetermined specific key, to display a device list;
manipulation of the arrow keys, to select an external device among the device list; and
manipulation of the predetermined specific key, to request disconnection or reconnection of the external device, to the computer.

9. The computer system as set forth in claim 7 or 8, wherein the predetermined specific key is a special purpose key.

10. A method in a computer system comprising a computer, and a keyboard having predetermined specific key(s), the method comprising:
requesting the computer to perform a predetermined function for/of disconnection or reconnection of an external device, by manipulation of the predetermined specific key(s); and
performing the predetermined function for/of disconnection or reconnection of an external device, in response to the manipulation,
wherein the predetermined function comprises one of the following: disconnection of the last connected external device(s), or reconnection of the last disconnected external device(s).
